(19) United States
(12) Patent Application Publication
(10) Pub. No.: US 2021/0385490 A1
(43) Pub. Date: Dec. 9, 2021

(54) IMMERSIVE VIDEO ENCODING AND DECODING METHOD

(71) Applicant: Electronics and Telecommunications Research Institute, Daejeon (KR)

(72) Inventors: Hong Chang SHIN, Daejeon (KR); Gwang Soon LEE, Daejeon (KR); Ho Min EUM, Daejeon (KR); Jun Young JEONG, Daejeon (KR); Kug Jin YUN, Daejeon (KR)

(73) Assignee: Electronics and Telecommunications Research Institute, Daejeon (KR)

(21) Appl. No.: 17/231,790

(22) Filed: Apr. 15, 2021

(30) Foreign Application Priority Data
Apr. 17, 2020 (KR) 10-2020-0047007
Apr. 15, 2021 (KR) 10-2021-0049191

(51) Int. Cl. H04N 19/597; H04N 19/157; H04N 19/14

(52) U.S. Cl. CPC H04N 19/597; H04N 19/14; H04N 19/157

(57) ABSTRACT

A video decoding method comprises receiving a plurality of atlases and metadata, unpacking patches included in the plurality of atlases based on the plurality of atlases and the metadata, reconstructing view images including an image of a basic view and images of a plurality of additional views, by unpruning the patches based on the metadata, and synthesizing an image of a target playback view based on the view images. The metadata is data related to priorities of the view images.

### CROSS REFERENCE TO RELATED APPLICATION

The present application claims priority to Korean Patent Application No. 10-2020-0047007 filed Apr. 17, 2020, and No. 10-2021-0049191 filed Apr. 15, 2021, the entire contents of which is incorporated herein for all purposes by this reference.

### BACKGROUND OF THE INVENTION

### 1. Field of the Invention

The present disclosure relates to an immersive video encoding and decoding method and, more particularly, to a method and apparatus for removing an overlapping component between view images based on priorities of view images of an immersive video and encoding and decoding the immersive video using the same.

### 2. Description of the Related Art

An immersive video is taken by using a rig equipped with a plurality of cameras arranged at a constant interval and direction. The immersive video provides images of a plurality of views to a viewer to enable the viewer to experience natural motion parallax, but has a disadvantage of storing a large amount of image data for multiple views.

Recently, as interest in realistic content has exploded and broadcast equipment and image transmission technology have been developed, there is an increasing movement to actively utilize realistic content in multimedia industries such as movies and TVs.

In order to provide an immersive video, a shooting apparatus should capture images of a plurality of views and provide the captured images of the plurality of views. As the number of captured images of the views increases, it is possible to generate three-dimensional content with a high degree of completion. However, since additional images need to be transmitted during transmission, there may be a problem of transmission bandwidth. In addition, multi-view high-quality images require a large storage space.

### SUMMARY OF THE INVENTION

An object of the present disclosure is to provide an immersive video generating method and apparatus capable of more efficiently supporting an omnidirectional degree of freedom by prioritizing reference images in a pruning process.

According to the present disclosure, provided is a video decoding of receiving a plurality of atlases and metadata; unpacking patches included in the plurality of atlases based on the plurality of atlases and the metadata; reconstructing view images including an image of a basic view and images of a plurality of additional views, by unpruning the patches based on the metadata; and synthesizing an image of a target playback view based on the view images, wherein the metadata is data related to priorities of the view images.

According to an embodiment, wherein the metadata comprises information on the number of priority levels assigned to the plurality of atlases.

According to an embodiment, wherein the metadata comprises first priority level information indicating priorities of the plurality of atlases among a plurality of priority levels according to the information on the number of priority levels, and wherein the unpacking the patches included in the plurality of atlases comprises determining priorities of the plurality of atlases according to the first priority level information.

According to an embodiment, wherein the metadata comprises second priority level information indicating priority of a current atlas, and wherein the unpacking the patches included in the plurality of atlases comprises determining priority of the current atlas according to the second priority level information.

According to an embodiment, wherein the metadata comprises view number information indicating the number of views applied to the priority of the current atlas.

According to an embodiment, wherein the metadata comprises view identifier information indicating identifiers of views applied to the priority of the current atlas, and wherein the unpacking the patches included in the plurality of atlases comprises determining a view applied to the current atlas according to the view identifier information.

According to an embodiment, wherein the metadata comprises third priority level information indicating priorities of the patches included in the plurality of atlases, and wherein the reconstructing the view images comprises unpruning the patches based on the metadata according to the third priority level information.

According to an embodiment, wherein the metadata comprises an identifier indicating a view matching the target playback view among the basic view and the plurality of additional views.

According to an embodiment, wherein the metadata comprises: an identifier of an adjacent view adjacent to the target playback view; and offset information indicating an offset of the target playback view from the adjacent view.

According to an embodiment, wherein the metadata comprises pruning priority level information of a pruning order of images of the plurality of additional views, and wherein the reconstructing the view images comprises unpruning the patches based on the metadata according to the pruning priority level information.

According to the present disclosure, provided is a video encoding method of designating priorities of view images including an image of a basic view and images of a plurality of additional views; generating patches by pruning the view images based on the priorities; generating a plurality of atlases, into which the patches are packed, based on the priorities; generating metadata based on the priorities; and encoding the plurality of atlases and the metadata.

According to an embodiment, the video encoding method further comprises generating first priority level information indicating priorities of the plurality of atlases among a plurality of priority levels according to information on the number of priority levels, and wherein the metadata comprises the information on the number of priority levels and the first priority level information.

According to an embodiment, the video encoding method further comprises generating second priority level information indicating priority of a current atlas, and wherein the metadata comprises the second priority level information.

According to an embodiment, wherein the metadata comprises view number information indicating the number of views applied to the priority of the current atlas.

According to an embodiment, the video encoding method further comprises generating view identifier information indicating identifiers of views applied to the priority of the current atlas, and wherein the metadata comprises the view identifier information.

According to an embodiment, the video encoding method further comprises generating third priority level information indicating priorities of the patches included in the plurality of atlases, and wherein the metadata comprises the third priority level information.

According to an embodiment, further comprising determining a target playback view, wherein the metadata comprises an identifier indicating a view matching the target playback view among the basic view and the plurality of additional views.

According to an embodiment, wherein the metadata comprises: an identifier of an adjacent view adjacent to the target playback view; and offset information indicating an offset of the target playback view from the adjacent view.

According to an embodiment, the video encoding method further comprises generating pruning priority level information of a pruning order of images of the plurality of additional views, and wherein the metadata comprises the pruning priority level information.

According to the present disclosure, provided is a non-transitory computer-readable storage medium including a bitstream decoded by a video decoding method, the video decoding method of receiving a plurality of atlases and metadata; unpacking patches included in the plurality of atlases based on the plurality of atlases and the metadata; reconstructing view images including an image of a basic view and images of a plurality of additional views, by unpruning the patches based on the metadata; and synthesizing an image of a target playback view based on the view images, wherein the metadata is data related to priorities of the view images.

The technical problems solved by the present disclosure are not limited to the above technical problems and other technical problems which are not described herein will become apparent to those skilled in the art from the following description.

According to the present disclosure, it is possible to a method and apparatus for synthesizing an image supporting an omnidirectional degree of freedom using a multi-view image.

In addition, according to the present disclosure, by synthesizing a multi-view image based on priorities of a plurality of view images, it is possible to provide a video synthesis method for efficiently synthesizing an immersive video.

### BRIEF DESCRIPTION OF THE DRAWINGS

FIG. 1 is a view illustrating a basic view image and additional view images obtained through different cameras.

FIG. 2 is a view illustrating a method of reducing overlapping image data between a basic view image and additional view images.

FIG. 3 is a view illustrating dependency between a basic view image and additional view images.

FIG. 4 is a view illustrating a first embodiment of dividing a basic view image and additional view images into a plurality of groups.

FIG. 5 is a view illustrating a second embodiment of dividing a basic view image and additional view images into a plurality of groups.

FIG. 6 is a view illustrating a third embodiment of dividing a basic view image and additional view images into a plurality of groups.

FIG. 7 is a view illustrating a first embodiment of packing patches generated from a basic view image and additional view images into a plurality of atlases.

FIG. 8 is a view illustrating a second embodiment of packing patches generated from a basic view image and additional view images into a plurality of atlases.

FIG. 9 is a view illustrating a third embodiment of packing patches generated from a basic view image and additional view images into a plurality of atlases.

FIG. 10 is a view illustrating an embodiment of a group-based pruning method.

FIG. 11 is a view illustrating a first embodiment in which a priority level is applied based on a pruning graph.

FIG. 12 is a view illustrating a second embodiment in which a priority level is applied based on a pruning graph.

FIG. 13 is a view illustrating an embodiment of a method of designating a preferential additional view image.

FIG. 14 is a block diagram illustrating an embodiment of an encoder and a decoder for transmitting and receiving an immersive video.

FIG. 15 is a view illustrating metadata declaring a priority level.

FIG. 16 is a view illustrating metadata for an atlas sequence.

FIG. 17 is a view illustrating metadata defining characteristics of an atlas.

FIG. 18 is a view illustrating metadata for an atlas identified by a particular identifier.

FIG. 19 is a view illustrating metadata for patches included in an atlas.

FIG. 20 is a view illustrating metadata for views of miv.

FIG. 21 is a view illustrating metadata for pruning priority.

FIG. 22 is a flowchart illustrating an embodiment of operation of an encoder for encoding an immersive video.

FIG. 23 is a flowchart illustrating an embodiment of operation of a decoder for decoding an immersive video.

### DESCRIPTION OF THE PREFERRED EMBODIMENTS

Hereinafter, embodiments of the present invention will be described in detail with reference to the accompanying drawings, which will be easily implemented by those skilled in the art. However, the present invention may be embodied in many different forms and is not limited to the embodiments described herein.

When an element is referred to as being “connected to” or “coupled with” another element, it can not only be directly connected or coupled to the other element but also it can be understood that intervening elements may be present. Also, in the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific element is referred to as being “included”, elements other than the corresponding element are not excluded, but additional elements may be included in embodiments of the present invention or the scope of the present invention.

Since the present invention may be changed and may have various embodiments, specific embodiments are illustrated in the drawings and described in the detailed description. However, it is not intended to limit the present disclosure to specific embodiments, and it should be understood to include all modifications, equivalents, and substitutes included in the spirit and scope of the present disclosure. The similar reference numerals refer to the same or similar functions in various aspects. In the drawings, the shapes and sizes of elements may be exaggerated for clarity. In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a certain feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled.

It will be understood that, although the terms including ordinal numbers such as “first”, “second”, etc. may be used herein to describe various elements, these elements are not limited by these terms. These terms are only used to distinguish one element from another. For example, a second element could be termed a first element without departing from the teachings of the present inventive concept, and similarly a first element could be also termed a second element.

The components as used herein may be independently shown to represent their respective distinct features, but this does not mean that each component should be configured as a separate hardware or software unit. In other words, the components are shown separately from each other for ease of description. At least two of the components may be combined to configure a single component, or each component may be split into a plurality of components to perform a function. Such combination or separation also belongs to the scope of the present invention without departing from the gist of the present invention.

Terms used in the application are merely used to describe particular embodiments and are not intended to limit the present disclosure. A singular expression includes a plural expression unless the context clearly indicates otherwise. In the application, terms such as “include” or “have” are should be understood as designating that features, number, steps, operations, elements, parts, or combinations thereof exist and not as precluding the existence of or the possibility of adding one or more other features, numbers, steps, operations, elements, parts, or combinations thereof in advance. That is, the term “including” in the present disclosure does not exclude elements other than the corresponding element but means that an additional element may be included in the practice of the present invention or the scope of the technical spirit of the present invention.

Some elements may not serve as necessary elements to perform an essential function in the present invention but may serve as selective elements to improve performance. The present invention may be embodied by including only necessary elements to implement the spirit of the present invention excluding elements used to improve performance, and a structure including only necessary elements excluding selective elements used to improve performance is also included in the scope of the present invention.

Hereinbelow, reference will now be made in detail to the preferred embodiments of the present invention, examples of which are illustrated in the accompanying. In the detailed description of the preferred embodiments of the disclosure, however, detailed depictions of well known related functions and configurations may be omitted so as not to obscure the art of the present disclosure with superfluous detail. Also, the same or similar reference numerals are used throughout the different drawings to indicate similar functions or operations.

Hereinafter, embodiments of the present invention will be described with reference to the accompanying drawings.

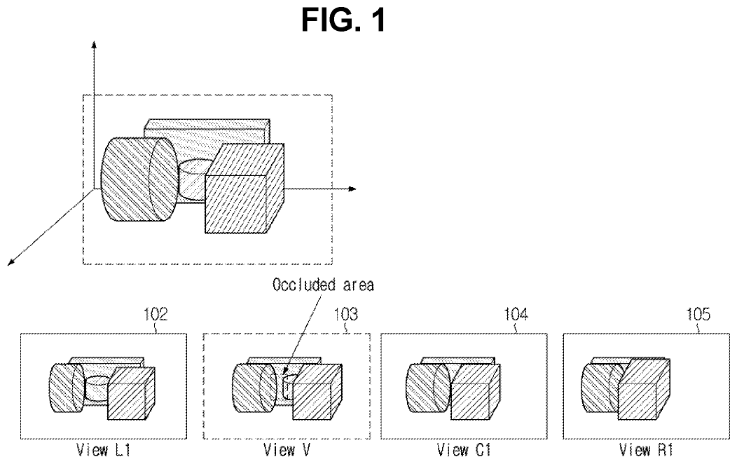

FIG. 1 is a view illustrating a basic view image and additional view images obtained through different cameras. Among the multiple view images, one or more basic view images are designated as a root node. The remaining images are additional view images.

Referring to FIG. 1, 104 denotes an image of a view of Center 1, and 102 and 105 respectively denote images of views of Left 1 and Right 1. 103 denotes an image generated using additional view images and represents an image of a virtual view located between 102 and 104. As shown in FIG. 1, 103 further includes an occluded area, which is not represented in 104. The occluded area is partially represented in 102 and thus a decoder may reference 102 during image synthesis of 103.

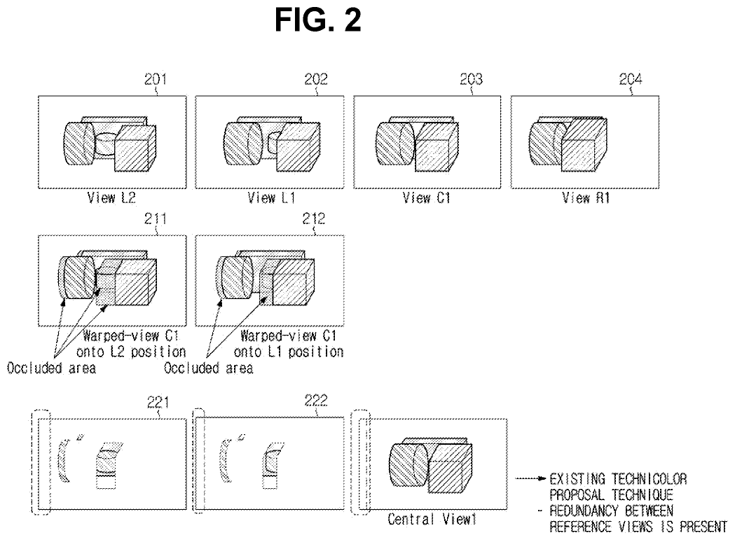

FIG. 2 is a view illustrating a method of reducing overlapping image data between a basic view image and additional view images.

Referring to FIG. 2, a method of reducing overlapping image data between a basic view image and other additional view images when a basic view image is located in the center is shown. In the embodiment of FIG. 2, it is assumed that the basic view image is 203, and the remaining view images may be additional view images.

An encoder may perform three-dimensional (3D) view warping operation using a 3D geometric relationship among additional view images, and depth information of additional view images. The encoder may map the additional view images and generate 211 and 212, as a result of 3D view warping. In an area which is not represented in 203, a hole not including data is generated like black areas of 211 and 212. The remaining area other than the hole may be an area shown in 203.

The encoder may check and remove an overlapping area between 201 and 211 and between 202 and 212. In order to remove the overlapping area, the encoder may check the overlapping area, by comparing pixel-wise texture data and depth information of an image mapped within a certain range of the same coordinates and/or particular coordinates.

As a result of determining whether there is an overlapping area, the encoder generates a residual image corresponding to additional views like 221 and 222. Here, the residual image refers to an image which is not visible in a basic view image and is represented only in the additional view image.

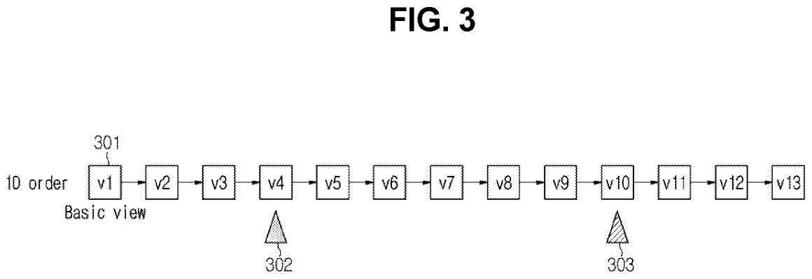

FIG. 3 is a view illustrating dependency between a basic view image and additional view images.

In recent MPEG-I, as shown in FIG. 3, an encoder determines a basic view image 301 and a pruning order of subsequent additional views. The encoder determines dependency between view images. The basic view image is an root node, is not pruned and has information on all pixels. In addition, additional view images which are lower(child) nodes with dependency on the basic view image are subjected to a pruning process. As a result of the pruning process, the additional view images have information on pixels excluding overlapping pixels with an upper(parent) node.

According to the embodiment shown in FIG. 3, v1 is selected as a basic view image, v2 is a child node of v1, v3 is a child node of v2, and v4 is a child node of v3. In addition, all view images are repeatedly connected as dependency of a one-dimensional array.

In FIG. 3, in order to reconstruct v4, a decoder searches v3 corresponding to an parent node for a pixel of an overlapping area present in v4. When the pixel of the overlapping area is present in v3, the decoder may reference a pixel present in v3. In contrast, when the pixel of the overlapping area is not present v3, the decoder searches v2, which is an parent node, for the pixel of the overlapping area present in v4.

That is, as a result of recursively searching the parent node, the decoder obtains a reference pixel. In addition, the decoder may reconstruct a view image using the obtained reference pixel. Such an image reconstruction process is referred to as unpruning. That is, the decoder for performing the unpruning process may search an parent node for information which is not present in a current view image. When there is a corresponding pixel in an parent node, the corresponding pixel is obtained and, when there is no corresponding pixel, the decoder may recursively search for the corresponding pixel by searching a next parent node for the corresponding pixel.

In FIG. 3, since v10 is located after v4 in pruning order, the decoder may reference more ancestor nodes in order to reconstruct v10. Accordingly, the decoder consumes more time in the unpruning process of v10 than the unpruning process of v4. As a additional image to be reconstructed is in the lower order, dependency between view images becomes stronger. Accordingly, the decoder references more additional images upon reconstructing the additional image. That is, computational complexity of the reconstruction increases.

For example, in FIG. 3, when spatial random access is performed at positions 302 and 303, the decoder may reference up to three view images to reconstruct 302 and reference up to 9 view images to reconstruct 303. Alternatively, the decoder may first reconstruct and then reference up to three view images to reconstruct 302 and first reconstruct and then reference up to 9 view images to reconstruct 303.

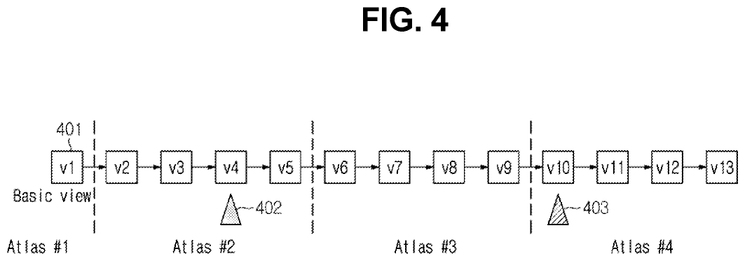

FIG. 4 is a view illustrating a first embodiment of dividing a basic view image and additional view images into a plurality of groups.

Referring to FIG. 4, an encoder may divide input view images into a plurality of groups. For example, the encoder may set a basic view image and a non-basic view image as separate groups. Alternatively, the encoder may set the basic image and the non-basic image to be included in one small group.

In addition, the encoder may equally set the number of non-basic view images included in one group. Alternatively, the encoder may variably set the number of non-basic view images for each group.

Alternatively, the encoder may group view images based on at least one of node depths of view images or adjacency between nodes.

FIG. 4 shows an embodiment in which input view images are divided into four small groups. Arrow shown in FIG. 4 indicate pruning priority on a pruning graph. A view image located at a child node may be pruned using a view image located at an parent node. That is, a view image vN at an N-th position has dependency on a basic view image v1 to a view image v(N−1).

The encoder may prune view images belonging to small groups and remove overlapping pixels between view images. Thereafter, the encoder may perform post-processing for patch packing to divide view images into patch units and construct an atlas. Here, the encoder may generate an atlas for each small group or group patches for each small group in the atlas. The generated atlas image is encoded and transmitted to a decoder along with metadata.

In the example of FIG. 4, atlas #1 includes only a basic view image and atlas #2 to atlas #4 include four view images.

The decoder obtains four atlases, by receiving a stream including four atlases and decoding the stream. The decoder, which has obtained the atlases, reconstructs view images by performing unpruning with respect to the atlases. The reconstructed view images are used as input images for synthesizing a virtual view image which is a view image at an arbitrary position.

According to an embodiment, the decoder needs to reference v3 from v1 401 which is an parent node, in order to reconstruct v4 402 of FIG. 4. Since an atlas image is generated for each small group, the decoder references only two atlases (that is, atlas #1 and atlas #2) in order to reconstruct v4 402. That is, the decoder, which has reconstructed v4 402, does not reference atlases #3 and #4. In contrast, when v3 410 is reconstructed, the decoder requires v1 to v9, which are the ancestor nodes, and thus needs to reference all four atlases.

That is, the number of necessary atlas images may vary depending on the position of the view to be reconstructed.

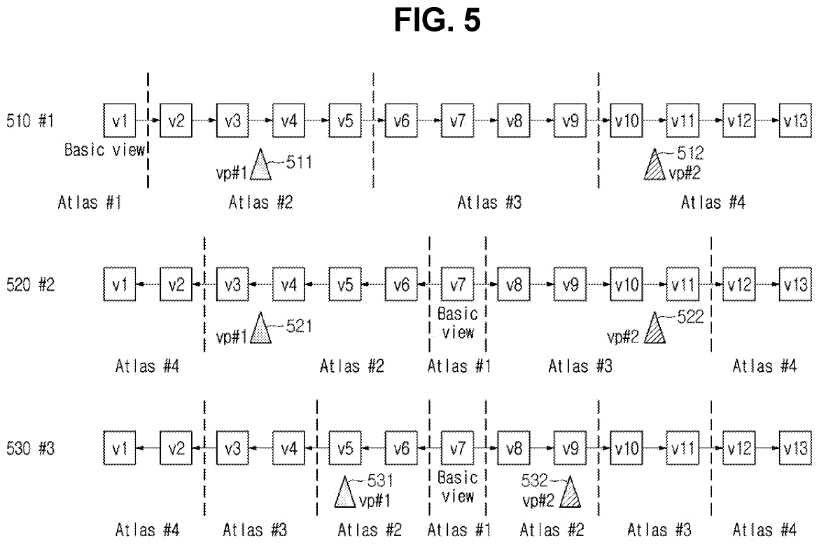

FIG. 5 is a view illustrating a second embodiment of dividing a basic view image and additional view images into a plurality of groups.

FIG. 5 shows three examples of the configuration of atlases including different view images according to the position. The configuration of FIG. 5 is preferably applicable to a camera array structure arranged in a row.

According to the embodiment of 510, v1 at the leftmost side is determined as a basic view image. In addition, the pruning order of view images may be determined in order adjacent to the basic view image v1.

511 and 512 indicate the positions of target virtual views. That is, the virtual view image 511 is an image of a virtual view between view images v3 and v4, and the virtual view image 512 is an image of a virtual view between v10 and v11.

In the embodiment of 510, in order to synthesize the virtual view image 511, the decoder preferentially references v3 and v4 which are images of views adjacent to the virtual view image 511. In some cases, the decoder for synthesizing the virtual view image 511 may additionally reference v2 and v5. In addition, the decoder may improve quality of the virtual view image, by further referencing the other view images.

Alternatively, the decoder may reference only some of adjacent view images according to resolution of the view images, depth information and accuracy of camera information, thereby improving a result of view image synthesis.

As a result, in order to synthesize the virtual view image 511, the decoder needs to reference a view image v3 adjacent to the left side of the virtual view image 511 and a view image v4 located at the right side of the virtual view image. According to the shown pruning dependency, the encoder needs to reference atlas #1 and atlas #2 in order to obtain the view images v3 and v4.

In order to synthesize the virtual view image 512, the decoder needs to reference at least view images v10 and v11 adjacent to the virtual view image 512. However, according to the shown pruning dependency, in order to reference the view images v10 and v11, the decoder needs to reference all four atlases.

For example, the number of required atlases may vary according to a view position to be rendered, and the number of views used for reference varies even in the atlas.

That is, according to the embodiment of 510, as a distance between the position of a target virtual view and a basic view increases, the number of atlases required for rendering excessively increases.

In order to solve such a problem, a basic view image may be set to have at least two child nodes. In addition, the view images may be grouped in consideration of a branching direction and/or a depth of the tree.

According to the embodiment of 520, a basic view image v7 may have two child nodes v6 and v8. The basic view image is designated as v7 and assigned to atlas #1. Additional view images may be grouped into one or more groups according to the orientation and position from the basic view image.

According to an embodiment, the child node v6 and nodes derived from the child node v6 may belong to a group different from that of the child node v8 and nodes derived from the child node v8.

The decoder for synthesizing a virtual view image 521 needs to preferentially reference v3 and v4 which are view images adjacent to the virtual target view image. According to the embodiment of 520, the decoder may synthesize the virtual view image 521, by referencing only atlases #1 and #2. Similarly, the decoder for synthesizing a virtual view image 522 may synthesize the virtual view image 522 by referencing only atlases #1 and #3.

The embodiment of 530 shows a grouping method considering the depths of the tree. According to the embodiment of 530, additional view images having the same depth may belong to the same group.

When the basic view image is designated as v7, additional view images having the same distance from the basic view image v7 may be assigned to the same atlas. The decoder for synthesizing virtual view images 531 and 532 may synthesize the virtual view image by referencing only atlas #1 and atlas #2. FIG. 5 shows that pruning order varies according to the position of a target virtual view image. In addition, FIG. 5 shows that the number of preferentially required atlases varies according to the divided atlas position.

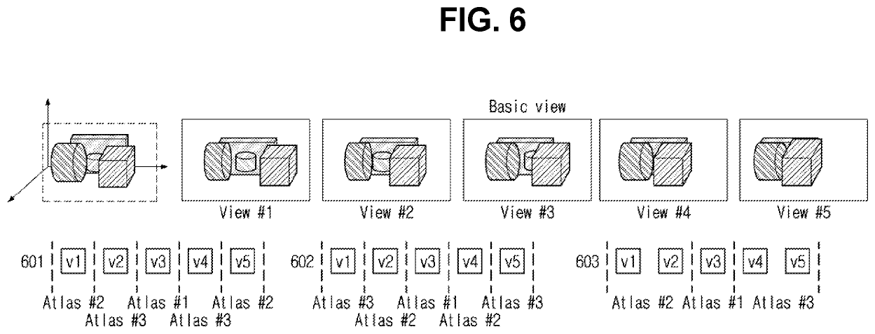

FIG. 6 is a view illustrating a third embodiment of dividing a basic view image and additional view images into a plurality of groups.

In determining the pruning order of view images, an encoder may consider the width of an overlapping area between an image designated as a basic view image or a view image designated as a higher order in pruning order and view images and/or the number of overlapping pixels. This is based on the assumption that, as the overlapping area between the view images increases, a probability that the sizes of the patches of additional views generated by the pruning process are large increases.

For example, in FIG. 6, as a additional view image is located farther from a basic view image v3, the width of the overlapping area between the additional view image and the basic view image is highly likely to be smaller. As the extent of the overlapping area between the additional view image and the basic view image decreases, the encoder may set higher pruning priority of the additional view image. Accordingly, the encoder may efficiently remove overlapping data between the additional view images. For example, the pruning order after the basic view image may be determined to be v5, v4, v1, and v2.

The present disclosure proposes a method of improving a pruning order determination method.

First, in consideration of a target view area, the encoder determines one or more view images as higher order. The target view area may indicate the position of a view to be preferentially rendered in a decoder. In addition, the encoder determines, as higher order, one or more view images in which a minimum range of a referenceable area may be designated.

In determining the range of the referenceable area, the encoder may consider orientation of a view as well as the overlapping area between the view images.

FIG. 6 is a view illustrating a third embodiment of dividing a basic view image and additional view images into a plurality of groups.

According to the embodiment of 601, a basic view image v3 may be designated as atlas #1 and referenceable areas centered on the basic view v3 may be set as leaf nodes (that is, to cover the entire area (area visible from all views)). Since the leaf nodes v1 and v5 are designated as atlas #2, the decoder may synthesize view images of all positions between v1 and v5, by referencing only atlas #1 and atlas #2. However, the decoder may improve the quality of the synthesized view images between the v1 and v5, by additionally referencing atlas #3.

According to the embodiment of 602, a basic view image v3 may be designated as atlas #1 and referenceable areas centered on the basic view v3 may be set as neighboring nodes. The neighboring nodes v4 and v2 are designated as atlas #2 and the leaf nodes v1 and v5 are designated as atlas #3. Accordingly, the minimum number of atlases to be referenced may vary according to the position of a target view. According to the embodiment of 602, an area in which only two atlas images may be synthesized may be narrower than that of the embodiment of 601. However, as a referenceable view image is closer to a basic view image, the quality of the synthesized image can be improved.

In 601 and 602, one atlas includes additional view images in both orientations, based on the basic view. In contrast, according to the embodiment of 603, a preferentially referenceable area is set to v1 and v2 in a particular orientation, based on the basic view v3. If the position of the target virtual view is predicted or intended to the left of the basic view v3, the decoder may synthesize the given target view image with the best quality, by preferentially referencing only atlas #1 and atlas #2.

As described above, when the image at a target virtual view position with input view images is rendered, the encoder sets priority levels of view images in consideration of whether the view images are preferentially referenced. In addition, the encoder distributes patches of a additional view image generated as the result of pruning based on the priority levels to atlases and packs the same. In this case, the encoder may transmit designated priority levels in the form of metadata.

The atlas is a physical unit in which patches of each view are packed. In addition, the priority level is a logical unit for prioritizing patches based on the probability of each of the patches to be used in synthesizing or rendering considering dependency among view images linked to a pruning graph or pruning order. That is, the priority level of the present disclosure may not be necessarily identical to an atlas number.

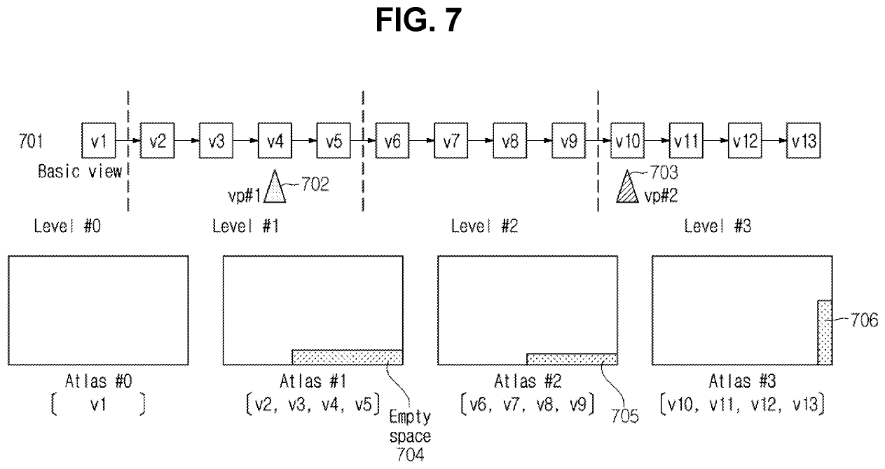

FIG. 7 is a view illustrating a first embodiment of packing patches generated from a basic view image and additional view images into a plurality of atlases.

Referring to FIG. 7, the priority level and the atlas number may be identical to each other. Patches of view images having the same priority level may be packed into one atlas. FIG. 7 shows an ideal embodiment in which patches occupy most of an atlas area and the atlas has less empty space. In this case, the atlas and the priority level may have the same concept.

In order to reconstruct a additional view image 702 through an unpruning process, a decoder may reconstruct the additional view image 702, by preferentially referencing only atlas #0 and #1 among a total of four atlases. In addition, in order to reconstruct a additional view image 703 through an unpruning process, a decoder may reconstruct the additional view image 703, by referencing all four atlases.

However, the case where the priority level and the atlas number are identical may stochastically restrictively occur.

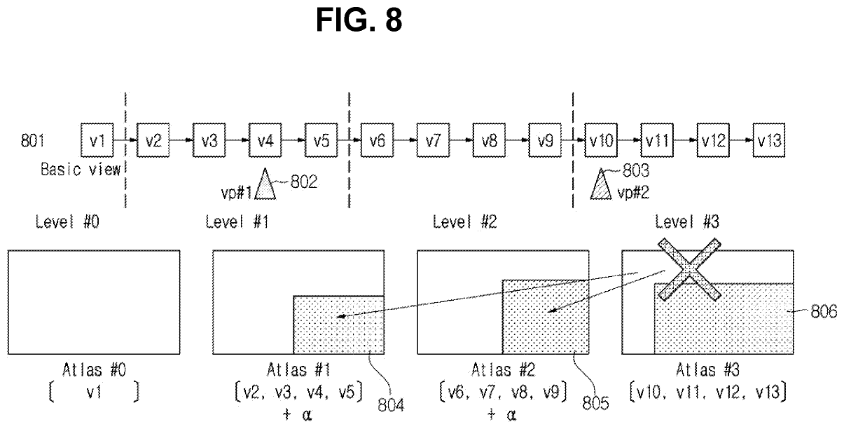

FIG. 8 is a view illustrating a second embodiment of packing patches generated from a basic view image and additional view images into a plurality of atlases.

Referring to FIG. 8, patches of view images having the same priority level in an atlas image may occupy a relatively small percentage of area. As shown in FIG. 8, when the percentage of the empty area is large in the atlas, data corresponding to the empty area is wasted.

Atlas #3, into which patches of view images having a lowest priority level is packed, is in lower order to be reconstructed and referenced last in pruning order. Accordingly, atlas #3 may not affect the unpruning process even if atlas #3 is divisionally placed in atlas #1 and atlas #2 in consideration of spatial random access.

Accordingly, as shown in FIG. 8, if all patches of atlas #3 are divisionally placed in atlases #1 and #2, it is possible to reduce the number of atlases and the empty space of the atlas. As a result, atlas #1 may include patches generated from additional view images v2, v3, v4, and v5 and a portion of atlas #3, and atlas #2 may include patches generated from additional view images v6, v7, v8, and v9 and a portion of atlas #3.

Accordingly, the decoder for reconstructing a additional view image 802 through the unpruning process may reconstruct the additional view image 802, by preferentially referencing only atlas #0 and atlas #1 among a total of four atlases. The decoder for reconstructing a additional view image 803 through the unpruning process may reconstruct the additional view image 803, by referencing all three atlases.

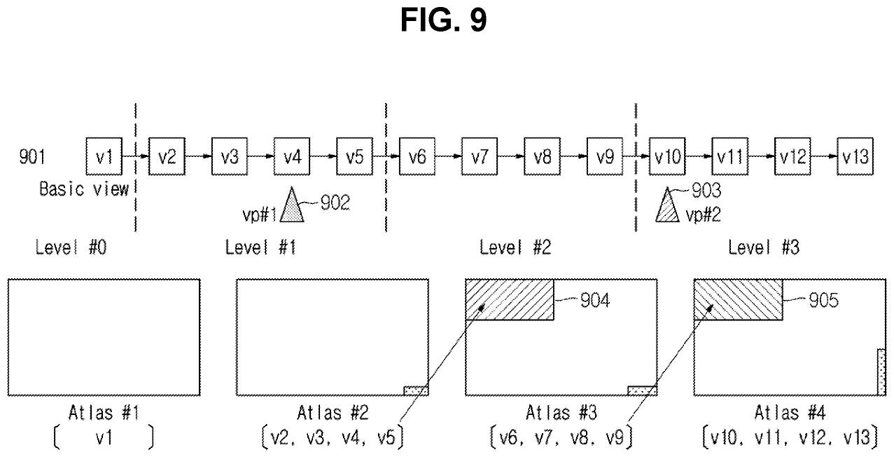

FIG. 9 is a view illustrating a third embodiment of packing patches generated from a basic view image and additional view images into a plurality of atlases.

FIG. 9 shows an embodiment in which patches of view images having the same priority level have a larger size than one atlas and are divided and packed into two or more atlases.

According to data complexity and/or the pruning process, patches of view images having the same priority level may be divided and packed into two or more atlases. Even in this case, an encoder may determine the number of atlas images for target view synthesis, by dividing atlases by priority levels. However, in order to reduce the number of atlas image references as the original purpose of setting the priority level, the encoder may adjust the priority levels of the atlases in the pruning process.

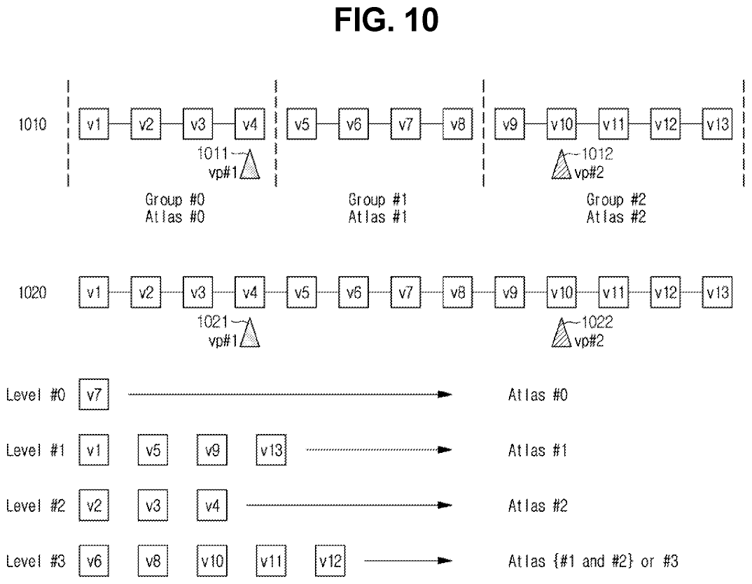

FIG. 10 is a view illustrating an embodiment of a group-based pruning method.

Referring to FIG. 10, 1010 shows an embodiment of view images grouped into a plurality of groups based on the positions of views. A separate atlas is assigned for each group. Pruning is applicable to view images in the same group.

Since a additional view image 1011 is included in group #0, only atlas #0 is referenced to reconstruct the additional view image 1011. In addition, since a additional view image 1012 is included in group #2, only atlas #2 is referenced to reconstruct the additional view image 1012. A decoder may perform spatial random access in reconstructing 1011 and 1012.

However, when a group-based pruning method is used, a decoder needs to reference all view images of two groups in order to synthesize a target virtual view image located between two views (e.g., between v4 and v5 or between v8 and v9) belonging to different groups.

1020 shows an embodiment, to which a priority level proposed by the present disclosure is applied. For example, the priority level of a basic view image v7 may be designated as level #0 and the priority levels of the remaining view images may be designated as level #1 to #3. Additional view images which are not consecutive in space may have the same priority level.

For example, the priority level of additional view images v1, v5, v9, and v10 may be designated as priority level #1. An encoder may designate the priority level by sparsely selecting additional view images. Accordingly, the decoder may perform spatial random access at all positions between v1 and v13 even if atlas #0 and atlas #1 are preferentially referenced.

Atlas #2 and atlas #3 include patches of views which may be additionally referenced according to the priority. When the decoder references all patches, it is possible to synthesize an image with improved quality, as compared to the case where only some patches are preferentially referenced.

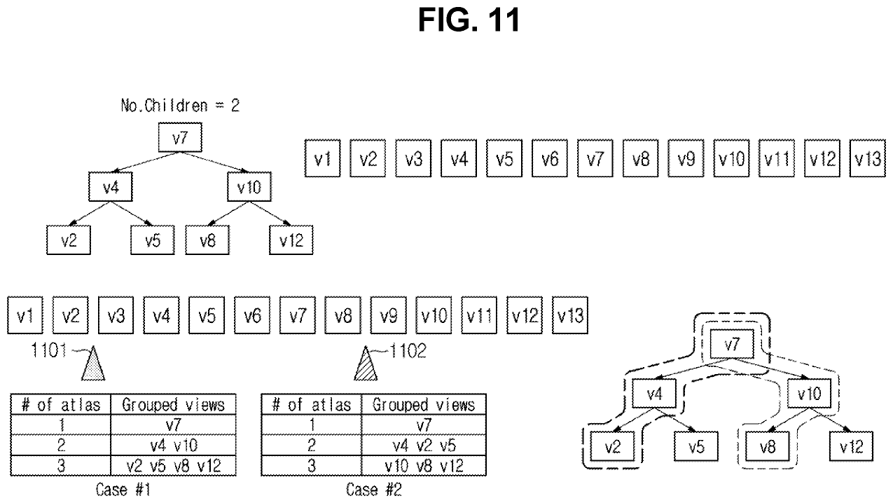

FIG. 11 is a view illustrating a first embodiment in which a priority level is applied based on a pruning graph.

According to the embodiment of FIG. 11, when a pruning graph is configured in a tree structure, a additional view image v2 has dependency on a additional view image v4, which is an parent node, and a basic view image v7. An encoder may assign view images having the same node depth to one atlas or assign view images to atlases in consideration of a tree branch.

The embodiment of Case #1 shows the case where view images are prioritized according to the node level of the pruning graph and are respectively assigned to atlases. In addition, the embodiment of Case #2 shows an example in which view images are grouped according to a branch from an root node of the pruning graph tree.

According to an embodiment, the encoder may group view images following a branch of v4 as one group and group view images following a branch of v10 as one group.

In Case #1, in order to synthesize a virtual view image 1102 between v4 and v10, the decoder may preferentially reference atlas #1 and atlas #2 centered on a basic view image v7. In addition, in Case #2, in order to synthesize a virtual view image 1101 located between v2 to v7 corresponding to the left of v7, the decoder may preferentially reference atlas #1 and atlas #2.

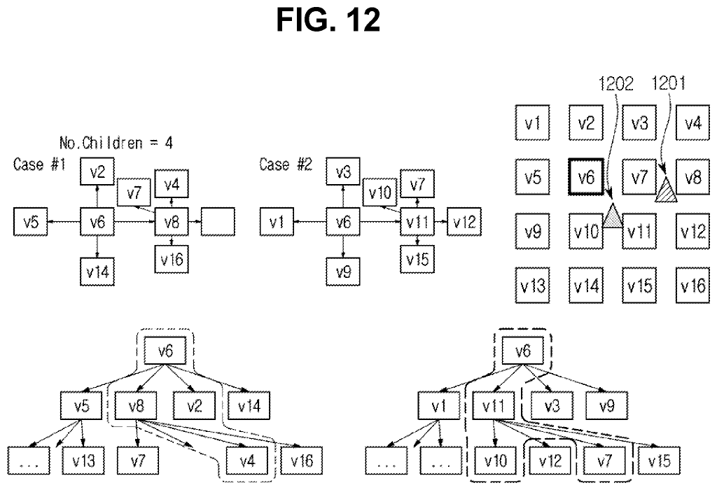

FIG. 12 is a view illustrating a second embodiment in which a priority level is applied based on a pruning graph.

According to the embodiment of FIG. 12, when a pruning group is configured in a tree structure, a basic view image v6 has dependency on four additional view images. An encoder may assign view images to atlases according to the tree branch of the pruning graph.

In Case #1, in order to synthesize a virtual view image 1201 between v7 and v8, the decoder may preferentially reference atlas #1 including a basic view image v6 and additional view images v2, v4, and v8. In addition, in Case #2, in order to synthesize a virtual view image 1202 between v10 to v11, the decoder may preferentially reference atlas #2 including a basic view image v6 and additional view images v7, v10, and v11.

That is, according to the embodiment of FIG. 12, when nodes have three or more child nodes, the decoder may expansively apply an atlas corresponding to a priority level to the three or more child nodes.

The target playback view position information mentioned in FIGS. 11 and 12 may be predetermined from a encoder. Alternatively, the target playback view position information may be transmitted to the encoder through bidirectional communication from a decoder. The target playback view position information may be a virtual view position predefined or defined in a basic view or a additional view.

There may be a need for a method of designating a preferential additional view image based on the target playback view position information and defining priorities of additional images. A priority definition method may be predefined through user input. The encoder may automatically designate a preferential additional view image in consideration of the defined target playback view position information.

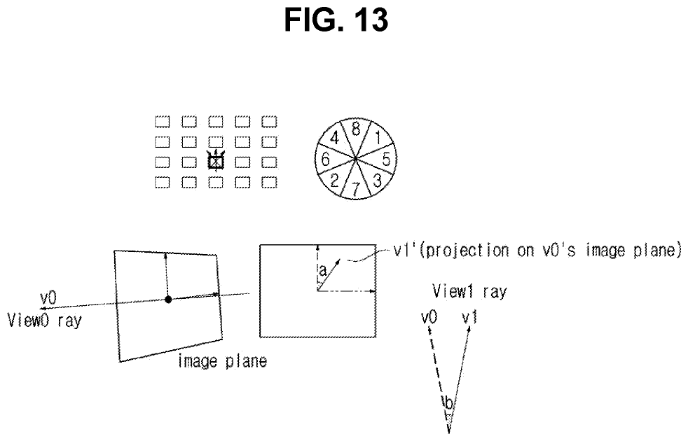

FIG. 13 is a view illustrating an embodiment of a method of designating a preferential additional view image.

Referring to FIG. 13, a view at the center in a grid structure in which five cameras are horizontally arranged and four cameras are arranged may be defined as a target playback view. An encoder calculates an overlapping area with an adjacent additional view from a target playback view position.

In addition, as shown in FIG. 13, the encoder divides all directions based on a basic view, that is, 360 degrees, into eight sections. In addition, the encoder may determine a priority level according to a section including a target playback view among the eight sections. Although 360 degrees are divided into eight sections in FIG. 13, the number of sections may be greater or less than eight.

The encoder may know orientation of a additional view compared to a basic view through an outer product of a viewing ray between the basic view and the additional view. In addition, the encoder may calculate an angle between the views through an inner product of the viewing ray between the basic view and the additional view.

In the embodiment of FIG. 13, the encoder divides an orientation known through outer product into eight sections and groups additional view images based on the divided orientation sections. The encoder may sequentially select a additional view one by one from groups by referencing the priority of the orientation. The encoder, which has determined the pruning order, may configure a preferential minimum additional view area capable of rendering a basic view corresponding to a target playback view. Accordingly, when performing spatial access random based on the preferential minimum additional view area configured by the encoder, a decoder may perform unpruning and synthesis of a target playback view through preferential reference.

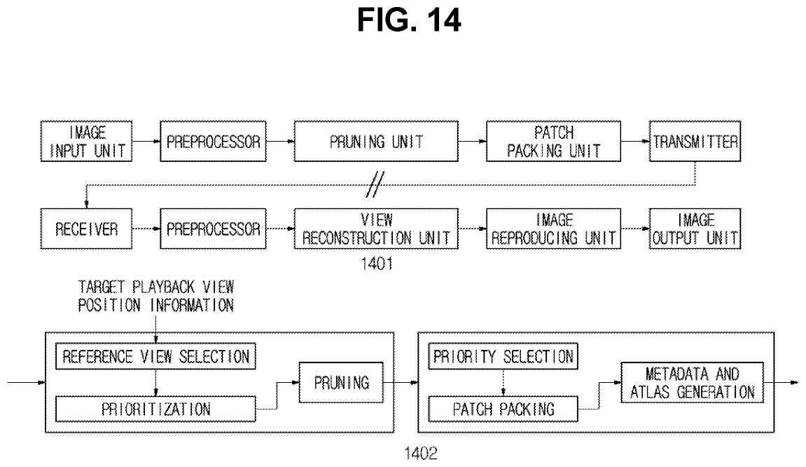

FIG. 14 is a block diagram illustrating an embodiment of an encoder and a decoder for transmitting and receiving an immersive video.

Referring to FIG. 14, 1401 shows a test model for immersive video defined in an MPEG-I Visual group. A preprocessor, which has obtained input image, designates a basic view image and additional view images from the input image, and performs preprocessing for a pruning order and/or a pruning graph configuration. A pruning unit determines the pruning order of the basic view image and the additional views and generates a pruning graph as metadata. In addition, the pruning unit performs pruning based on the pruning graph to generate patches. A patch packing unit constructs atlases including texture and depth information for each frame in an intra-period unit based on the patches generated as the result of pruning. A transmitter encodes and transmits atlases and metadata.

A receiver receives and decodes the encoded atlases and metadata. A preprocessor unpacks patches of the atlases by referencing the metadata, in order to reconstruct view images by performing unpruning process. In addition, the preprocessor generates a pruned view image using the unpacked patches of the atlases. A view reconstruction unit reconstructs view images by performing unpruning using the pruned view image and the metadata. An image reproducing unit synthesizes an image at an arbitrary view using the reconstructed view images. In addition, an image output unit outputs the synthesized image.

A method proposed by the present disclosure is applied to 1402. When target playback view position information is previously given to the pruning unit 1402, the pruning unit selects a preferential additional view through the target playback view position information. In addition, the pruning unit designates priority levels of additional view images based on the target playback view position information and the preferential additional view. The additional view images are pruned based on the pruning graph or the pruning order according to the priority level. A patch packing unit identifies the designated priority level and divisionally assigning patches by referencing the priority level, thereby packing the patches.

When the target playback view is not previously given, the encoder selects a basic view. In addition, the encoder may designate the priority levels of the additional views based on at least one of distances/positions of the additional views from the basic view.

When only some atlases are used due to an urgent situation such as spatial random access or limitation of decoder resources, the decoder preferentially reconstructs a additional view image with higher priority by referencing the priority level transmitted as metadata. In addition, the decoder synthesizes a target virtual view image using the reconstructed additional view image.

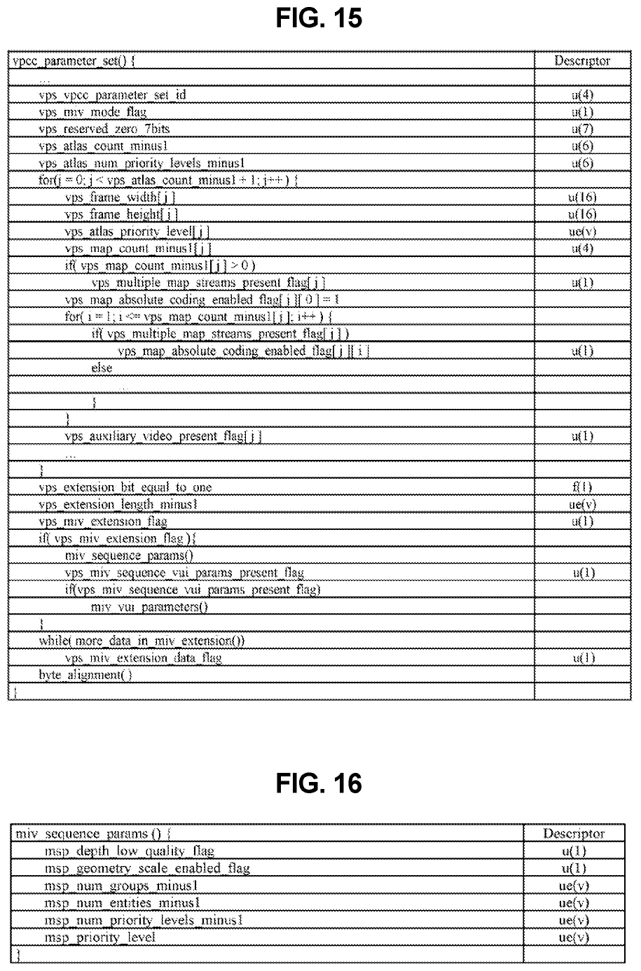

FIG. 15 is a view illustrating metadata declaring a priority level.

Referring to FIG. 15, vpcc_paramter_set is metadata defining a high-level concept including metadata for immersive video (miv). vpcc_paramter_set specifies the number of atlases. In addition, the number of atlases and a priority level may be related to each other. Accordingly, in vpcc_paramter_set, the number of priority levels is defined as vps_atlas_num_priority_level_minus1 and a priority level matching an atlas is defined as vps_atlas_priority_level. vps_atlas_priority_level may be declared as ue(v) as a dynamic vector because less than one atlas, one atlas or more than one atlas is assigned to a priority level.

FIG. 16 is a view illustrating metadata for an atlas sequence.

Referring to FIG. 16, miv_sequence_param is metadata on an atlas sequence defining the number of groups used in a miv atlas and the number of entities. In this case, in miv_sequence_param, the number of priority levels is defined as msp_num_priority_levels_minus1, and the priority level of the atlas is defined as msp_priority_level.

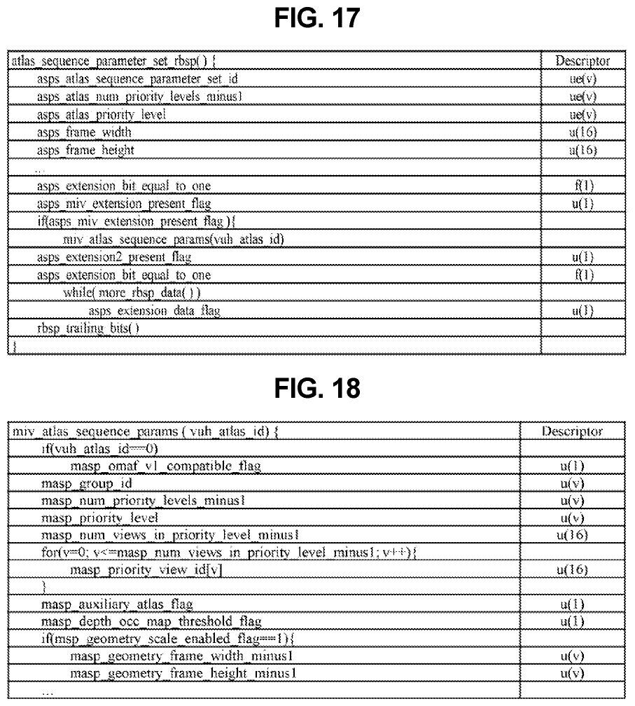

FIG. 17 is a view illustrating metadata defining characteristics of an atlas.

Referring to FIG. 17, atlas_sequence_paramter_set_rbsp is metadata defined for each atlas. atlas_sequence_paramter_set_rbsp defines the magnitude of atlas resolution and/or an atlas id. Here, atlas_sequence_paramter_set_rbsp may define priority levels for atlases. According to an embodiment, in atlas_sequence_paramter_set_rbsp, the number of priority levels may be defined as asps_atlas_num_priority_levels_minus1, and the priority levels of the atlases may be defined as asps_atlas_priority_level.

FIG. 18 is a view illustrating metadata for an atlas identified by a particular identifier.

Referring to FIG. 18, miv_atlas_sequence_params is metadata defined for each atlas. Specifically, miv_atlas_sequence_params defines metadata necessary to indicate the characteristics of an atlas identified by vuh_atlas_id. In this case, in miv_atlas_sequence_param, a total number of priority levels is defined as masp_num_priority_levels_minus1, and the priority level of the atlas is defined as masp_priority_level. In addition, miv_atlas_sequence_params defines information on view images included in the atlas. In miv_atlas_sequence_params, the number of view images included in the atlas may be defined as masp_num_views_in_priority_level_minus1, and the id of a view corresponding to the priority level may be defined through the following loop statement.

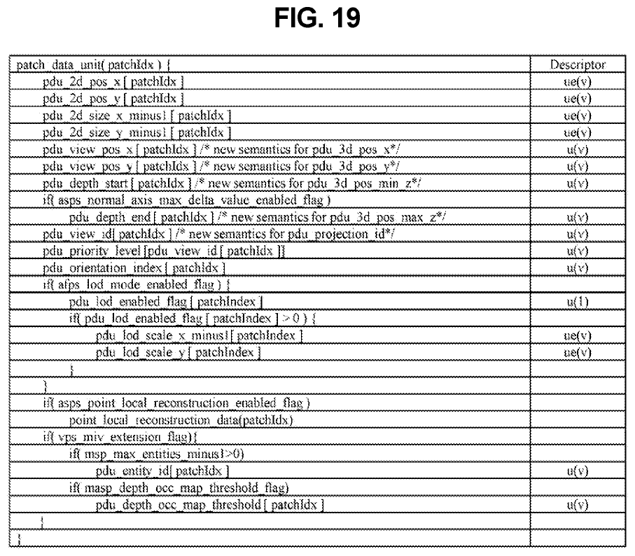

FIG. 19 is a view illustrating metadata for patches included in an atlas.

Referring to FIG. 19, patch data unit is metadata including information on patches included in the atlas. The patches included in the atlas may have priority levels. The metadata defines pdu_priority_level[pdu_view_id][patchIdx]] to indicate the priority levels of the patches through patchIdx which are the IDs of the patches.

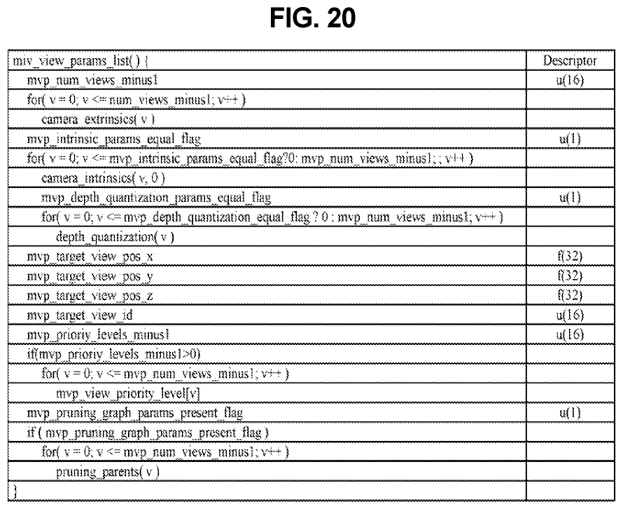

FIG. 20 is a view illustrating metadata for views of miv.

Referring to FIG. 20, miv_view_params_list( ) is metadata indicating information on each view of miv. Specifically, miv_view_params_list( ) is metadata indicating a total number of views or camera correction information. The metadata may have priority level information of views. Accordingly, in the metadata, the total number of priority levels is defined as mvp_priority_levels_minus1, and the priority level information of the views is defined as mvp_view_priority_level[v].

In addition, when the target playback view position information of FIG. 14 is predefined by the encoder of the transmitter or is transmitted from a receiver through a service such as video on demand (VOD), the encoder may define the target playback view position information as metadata. The target view position may be a basic view corresponding to an root node or one of additional views. The target playback view position information may be defined as mvp_target_view_id.

If the target playback view position is a virtual position, the metadata defines offset values on x, y and z axes for mvp_target_view_id at the target playback view position as mvp_target_view_pos_x, mvp_target_view_pos_y, mvp_target_view_pos_z. Alternatively, the metadata may include information indicating an offset value for two or more views at the target playback view position and two or more views adjacent to a virtual view position.

The metadata defining the priority level of FIG. 20 may designate the pruning order of view images, by referencing the target playback view position information and/or the basic view image.

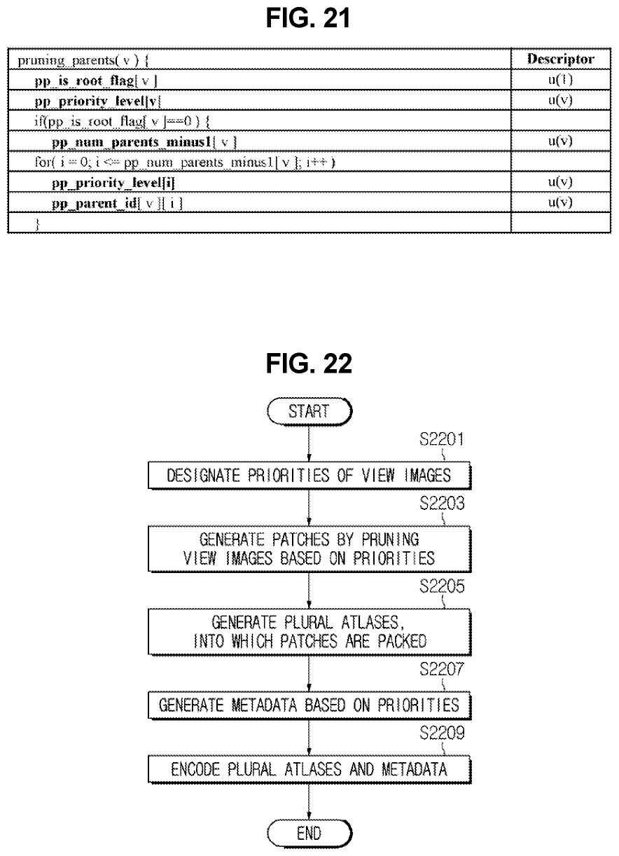

FIG. 21 is a view illustrating metadata for pruning priority.

Referring to FIG. 21, pruning parents (v) is metadata defining a pruning order calculated by the pruning unit. In order to define the pruning order, the metadata may define a priority level. The metadata may define the priority level as pp_priority_level.

FIG. 22 is a flowchart illustrating an embodiment of operation of an encoder for encoding an immersive video.

In step S2201, an encoder may designate priorities of view images including an image of a basic view and images of a plurality of additional views.

According to an embodiment, the encoder may designate the priorities of a plurality of atlases.

According to another embodiment, the encoder may designate the priorities of patches included in a plurality of atlases.

According to another embodiment, the encoder may determine a target playback view. In addition, the encoder may designate the priorities of the view images including an image of a basic view and images of a plurality of additional views based on the target playback view information.

According to another embodiment, the encoder may designate a pruning priority level for a pruning order of images of a plurality of additional views.

In step S2203, the encoder may generate patches by pruning the view images based on the priorities.

In step S2205, the encoder may generate a plurality of atlases, into which the patches are packed, based on the priorities.

In step S2207, the encoder may generate metadata based on the priorities.

According to an embodiment, the encoder may generate first priority level information indicating the priorities of a plurality of atlases among a plurality of priority levels according to information on the number of priority levels. The metadata may include information on the number of priority levels and the first priority level information.

According to another embodiment, the encoder may generate second priority level information indicating the priority of a current atlas. In addition, the metadata may include the second priority level information. Here, the metadata may include view number information indicating the number of views applied to the priority of the current atlas.

The encoder may generate view identifier information indicating the identifiers of views applied to the priority of the current atlas. In addition, the metadata may include view identifier information.

According to another embodiment, the encoder may generate third priority level information indicating the priorities of patches included in a plurality of atlases. In addition, the metadata may include the third priority level information.

When the encoder determines a target playback view, the metadata may include an identifier indicating a view matching a target playback view among a basic view and a plurality of additional views. Alternatively, the metadata may include an identifier of an adjacent view adjacent to the target playback view and offset information indicating an offset of the target playback view from the adjacent view.

When the encoder generates pruning priority level information of the pruning order of the images of the plurality of additional views, the metadata may include pruning priority level information.

In step S2209, the encoder may encode the plurality of atlases and the metadata. In addition, the encoder may transmit the plurality of encoded atlases and metadata to the decoder.

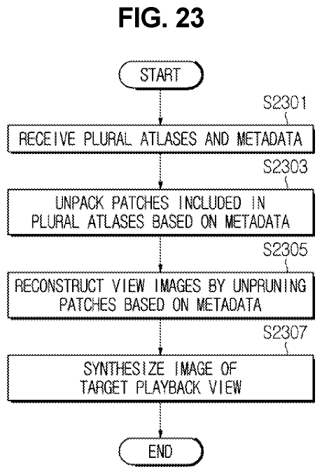

FIG. 23 is a flowchart illustrating an embodiment of operation of a decoder for decoding an immersive video.

In step S2301, the decoder may receive a plurality of atlases and metadata.

In step S2303, the decoder may unpack patches included in the plurality of atlases based on the plurality of atlases and the metadata.

According to an embodiment, the metadata may include information indicating the number of priority levels assigned to the plurality of atlases and first priority level information indicating the priorities of the plurality of atlases. In addition, the decoder may determine the priorities of the plurality of atlases according to the first priority level information and unpack the patches included in the atlases based on the determined priorities.

According to another embodiment, the metadata may include second priority level information indicating the priority of a current atlas. In addition, the decoder may determine priority of a current atlas according to the second priority level information and unpack the patches included in the atlases based on the determined priority of the current atlas. Here, the metadata may include view number information indicating the number of views applied to the priority of the current atlas.

According to another embodiment, the metadata may include view identifier information indicating the identifiers of views applied to the priority of the current atlas. In addition, the decoder may determine a view applied to the current atlas according to the view identifier information and unpack the patches included in the plurality of atlases based on the determined view.

In step S2305, the decoder may reconstruct view images including a basic view image and a plurality of additional view images, by unpruning the patches based on the metadata.

Here, the metadata may include an identifier indicating a view matching a target playback view among the basic view and the plurality of additional views. Alternatively, the metadata may include an identifier of an adjacent view adjacent to a target playback view and offset information indicating an offset of the target playback view from the adjacent view. According to an embodiment, the metadata may include third priority level information indicating the priorities of patches included in the plurality of atlases. The decoder may reconstruct view images by unpruning the patches based on the metadata according to the third priority level information.

According to another embodiment, the metadata may include pruning priority level information of the pruning order of the images of the plurality of additional views. The decoder may unprune the patches based on the metadata according to the pruning priority level information. In step S2307, the decoder may synthesize the image of the target playback view based on the view images.

In the above-described embodiments, the methods are described based on the flowcharts with a series of steps or units, but the present invention is not limited to the order of the steps, and rather, some steps may be performed simultaneously or in different order with other steps. It should be appreciated by one of ordinary skill in the art that the steps in the flowcharts do not exclude each other and that other steps may be added to the flowcharts or some of the steps may be deleted from the flowcharts without influencing the scope of the present invention.

Further, the above-described embodiments include various aspects of examples. Although all possible combinations to represent various aspects cannot be described, it may be appreciated by those skilled in the art that any other combination may be possible. Accordingly, the present invention includes all other changes, modifications, and variations belonging to the following claims.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable recording media includes magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a compiler but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modifications may be made without departing from the spirit and scope of the invention as defined in the following claims.

Accordingly, the thought of the present invention must not be confined to the explained embodiments, and the following patent claims, as well as everything including variations equal or equivalent to the patent claims, pertain to the category of the thought of the present invention.

What is claimed is:

1. A video decoding method comprising:
receiving a plurality of atlases and metadata;
unpacking patches included in the plurality of atlases based on the plurality of atlases and the metadata;
reconstructing view images including an image of a basic view and images of a plurality of additional views, by unpruning the patches based on the metadata; and
synthesizing an image of a target playback view based on the view images,
wherein the metadata is data related to priorities of the view images.

2. The video decoding method of claim 1, wherein the metadata comprises information on the number of priority levels assigned to the plurality of atlases.

3. The video decoding method of claim 2,
wherein the metadata comprises first priority level information indicating priorities of the plurality of atlases among a plurality of priority levels according to the information on the number of priority levels, and
wherein the unpacking the patches included in the plurality of atlases comprises determining priorities of the plurality of atlases according to the first priority level information.

4. The video decoding method of claim 1,
wherein the metadata comprises second priority level information indicating priority of a current atlas, and
wherein the unpacking the patches included in the plurality of atlases comprises determining priority of the current atlas according to the second priority level information.

5. The video decoding method of claim 4, wherein the metadata comprises view number information indicating the number of views applied to the priority of the current atlas.

6. The video decoding method of claim 5,
wherein the metadata comprises view identifier information indicating identifiers of views applied to the priority of the current atlas, and
wherein the unpacking the patches included in the plurality of atlases comprises determining a view applied to the current atlas according to the view identifier information.

7. The video decoding method of claim 1,
wherein the metadata comprises third priority level information indicating priorities of the patches included in the plurality of atlases, and
wherein the reconstructing the view images comprises unpruning the patches based on the metadata according to the third priority level information.

8. The video decoding method of claim 1, wherein the metadata comprises an identifier indicating a view matching the target playback view among the basic view and the plurality of additional views.

9. The video decoding method of claim 1, wherein the metadata comprises:
an identifier of an adjacent view adjacent to the target playback view; and
offset information indicating an offset of the target playback view from the adjacent view.

10. The video decoding method of claim 1,
wherein the metadata comprises pruning priority level information of a pruning order of images of the plurality of additional views, and
wherein the reconstructing the view images comprises unpruning the patches based on the metadata according to the pruning priority level information.

11. A video encoding method comprising:
designating priorities of view images including an image of a basic view and images of a plurality of additional views;
generating patches by pruning the view images based on the priorities;
generating a plurality of atlases, into which the patches are packed, based on the priorities;
generating metadata based on the priorities; and
encoding the plurality of atlases and the metadata.

12. The video encoding method of claim 11, comprising generating first priority level information indicating priorities of the plurality of atlases among a plurality of priority levels according to information on the number of priority levels, and
wherein the metadata comprises the information on the number of priority levels and the first priority level information.

13. The video encoding method of claim 11, comprising generating second priority level information indicating priority of a current atlas, and
wherein the metadata comprises the second priority level information.

14. The video encoding method of claim 13, wherein the metadata comprises view number information indicating the number of views applied to the priority of the current atlas.

15. The video encoding method of claim 14, comprising generating view identifier information indicating identifiers of views applied to the priority of the current atlas, and
wherein the metadata comprises the view identifier information.

16. The video encoding method of claim 11, comprising generating third priority level information indicating priorities of the patches included in the plurality of atlases, and
wherein the metadata comprises the third priority level information.

17. The video encoding method of claim 11, further comprising determining a target playback view,
wherein the metadata comprises an identifier indicating a view matching the target playback view among the basic view and the plurality of additional views.

18. The video encoding method of claim 17, wherein the metadata comprises:
an identifier of an adjacent view adjacent to the target playback view; and
offset information indicating an offset of the target playback view from the adjacent view.

19. The video encoding method of claim 11, comprising generating pruning priority level information of a pruning order of images of the plurality of additional views, and
wherein the metadata comprises the pruning priority level information.

20. A non-transitory computer-readable storage medium including a bitstream decoded by a video decoding method, the video decoding method comprising:
receiving a plurality of atlases and metadata;
unpacking patches included in the plurality of atlases based on the plurality of atlases and the metadata;
reconstructing view images including an image of a basic view and images of a plurality of additional views, by unpruning the patches based on the metadata; and
synthesizing an image of a target playback view based on the view images,
wherein the metadata is data related to priorities of the view images.
